(19) United States
(12) Patent Application Publication
(10) Pub. No.: US 2009/0063894 A1
(43) Pub. Date: Mar. 5, 2009

(54) Autonomic PCI Express Hardware Detection and Failover Mechanism

(76) Inventors: Ronald L. Billau, Rochester, MN (US); John D. Folkerts, Rochester, MN (US); Ross L. Franke, Fochester, MN (US); James S. Harveland, Byron, MN (US); Brian G. Holthaus, Oronoco, MN (US)

Correspondence Address: IBM CORPORATION, 3605 HIGHWAY 52 NORTH, DEPT 917, ROCHESTER, MN, 55901-7829, US

(21) Appl. No.: 11/846,783

(22) Filed: Aug. 29, 2007

(51) Int. Cl. G06F 11/07; G06F 13/00; G06F 13/14

(52) U.S. Cl. 714/5; 710/104; 710/305; 714/E11.112

(57) ABSTRACT

A system with an autonomic PCI Express hardware detection and failover mechanism includes a plurality of combination root complex capable and endpoint capable devices. A combination root complex capable and endpoint capable device may be selectively configured to operate in either a root complex mode or an endpoint mode. One of the devices assumes the root complex mode and the remaining devices each assume the endpoint mode. Each of the endpoint mode devices is adapted to detect a failure of the root complex mode device. In response to detection of the failure of the root complex mode device, one of the endpoint mode devices assumes root complex mode. An endpoint device may include a timer with a timeout value. Whenever, an endpoint device receives a communication from the root complex device, the endpoint device restarts its timer. If the timer times out with the endpoint device receiving a communication from the root complex device, the endpoint device issues a read request to the root complex device. If the root complex device does not respond to the read request, the endpoint device assumes root complex mode. Different endpoint devices may be assigned different timeout values. Accordingly, the endpoint device that is assigned the shortest time out value will assume root complex mode upon detection of a root complex device failure.

### BACKGROUND OF THE INVENTION

1. Technical Field

The present invention relates generally to the field of computer system input/output (I/O) buses, and more particularly to an autonomic PCI Express (PCIe) hardware detection and failover mechanism.

2. Description of the Related Art

PCI Express (PCIe) is the third generation high-performance I/O bus used to interconnect peripheral devices in applications such as computing and communication platforms. PCIe provides high-speed, high-performance, point-to-point, dual simplex, differential signaling links for interconnecting devices. A PCIe device can be a root complex, a switch, or an endpoint. A PCIe system includes one root complex and one or more endpoint devices. Since a root complex can connect directly to multiple endpoint devices, switches are optional.

The current PCIe protocol does not provide any mechanism for system recovery in the event that the root complex fails or otherwise becomes unavailable. Thus, failure of the root complex results in catastrophic system failure.

### SUMMARY OF THE INVENTION

The present invention provides an autonomic PCI Express hardware detection and failover mechanism. Embodiments of a system according to the present invention include a plurality of combination root complex capable and endpoint capable devices. A combination root complex capable and endpoint capable device may be selectively configured to operate in either a root complex mode or an endpoint mode. According to embodiments of the present invention, one of the devices assumes the root complex mode and the remaining devices each assume the endpoint mode. Each of the endpoint mode devices is adapted to detect a failure of the root complex mode device. In response to detection of the failure of the root complex mode device, one of the endpoint mode devices assumes root complex mode.

Embodiments of the present invention, each endpoint device includes a timer with a timeout value. Whenever, an endpoint device receives a communication from the root complex device, the endpoint device restarts its timer. If the timer times out with the endpoint device receiving a communication from the root complex device, the endpoint device issues a read request to the root complex device. If the root complex device does not respond to the read request, the endpoint device assumes root complex mode. Different endpoint devices may be assigned different timeout values. Accordingly, the endpoint device that is assigned the shortest time out value will assume root complex mode upon detection of a root complex device failure.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 is a block diagram of an embodiment of a system of multiple root complex and endpoint capable devices according to the present invention;

FIG. 2 is a block diagram of a multiprocessor system according to an embodiment of the present invention;

FIG. 3 is a block diagram of the multiprocessor system of FIG. 2 after failure of the root complex device;

FIG. 4 is a flow chart of endpoint device power-up processing according to an embodiment of the present invention; and,

FIG. 5 is a flow chart of failover processing according to an embodiment of the present invention.

### DETAILED DESCRIPTION OF THE PREFERRED EMBODIMENT

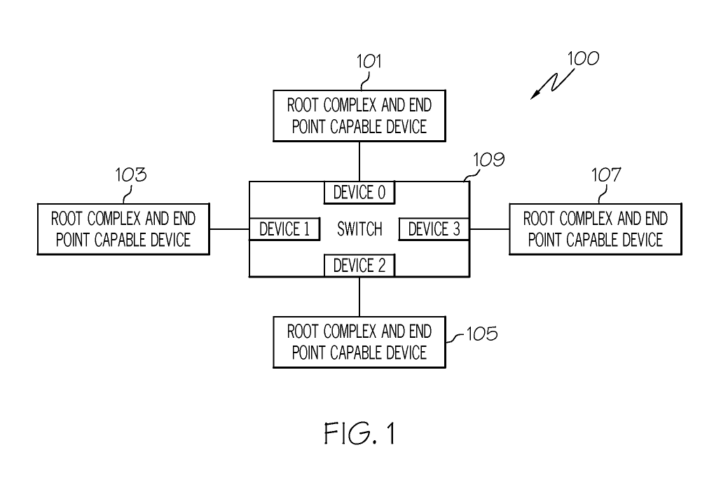

Referring now to the drawings, and first to FIG. 1, a system according to the present invention is designated generally by the numeral 100. System 100 includes a plurality of PCI express (PCIe) combination root complex and endpoint capable devices 105-107. Each root complex and endpoint capable device 101-107 is coupled to a switch 109. Each root complex and endpoint capable device 101-107 is configurable to operate in either a root complex mode or an endpoint mode. A root complex device connects a central processing unit (CPU) and memory subsystem to the PCIe fabric. The root complex device generates transaction requests, configuration transaction requests, and memory and I/O requests as well as locked transaction requests on behalf of the CPU. Endpoint devices are devices other than the root complex and switches that are requesters or completers of PCIe transactions. Switch 109 forwards packets between the root complex and endpoint devices using memory, I/O, or configuration address-based routing. Each root complex and endpoint capable device 101-107 is identified on switch 109 by a device number. In FIG. 1, root complex and endpoint capable device 101 is device 0, root complex and endpoint capable device 103 is device 1, root complex and endpoint capable device 105 is device 2, and root complex and endpoint capable device 107 is device 3. It will be recognized by those skilled in the art that a system according to the present invention may include, in addition to PCIe combination root complex and endpoint capable devices, PCIe endpoint-only devices, as well as legacy PCI and PCI Extended endpoint devices; however, only combination root complex and endpoint capable devices will participate in failover according to the present invention.

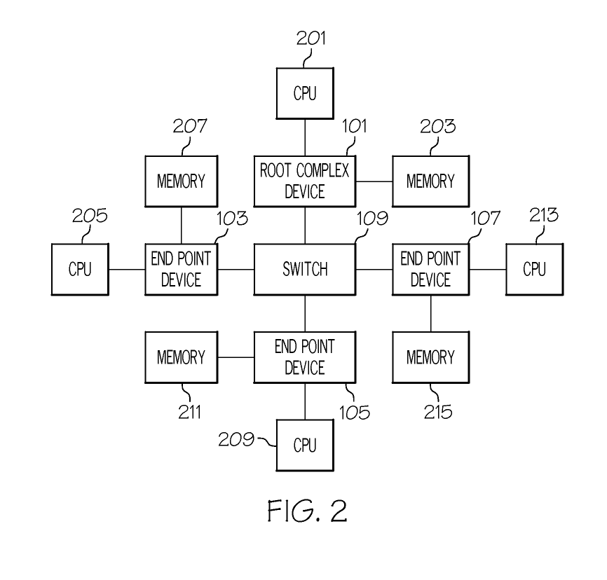

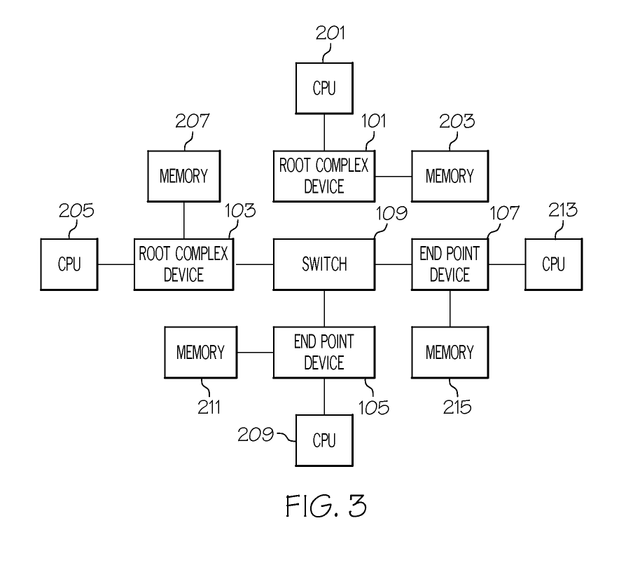

FIG. 2 illustrates a multiprocessor system incorporating an embodiment of a PCIe system according to the present invention. In FIG. 2, device 101 is configured in root complex mode. Devices 103-107 are each configured in endpoint mode. Root complex device 101 is coupled to a CPU 201 and memory 203. Endpoint device 103 is coupled to a CPU 205 and memory 207. Similarly, endpoint device 105 is coupled to a CPU 209 and memory 211. Finally, endpoint device 107 is coupled to a CPU 213 and memory 215. FIG. 3 illustrates the multiprocessor system of FIG. 2 after a failure of root complex device 101. As will be described in detail hereinafter, endpoint devices 103-107 are each adapted to detect the failure of root complex device 101. According to the present invention, the multiprocessor system reconfigures itself such that device 103 assumes root complex mode while devices 105 and 107 remain in endpoint mode. Thus, the multiprocessor system can continue to operate despite the failure of root complex device 101.

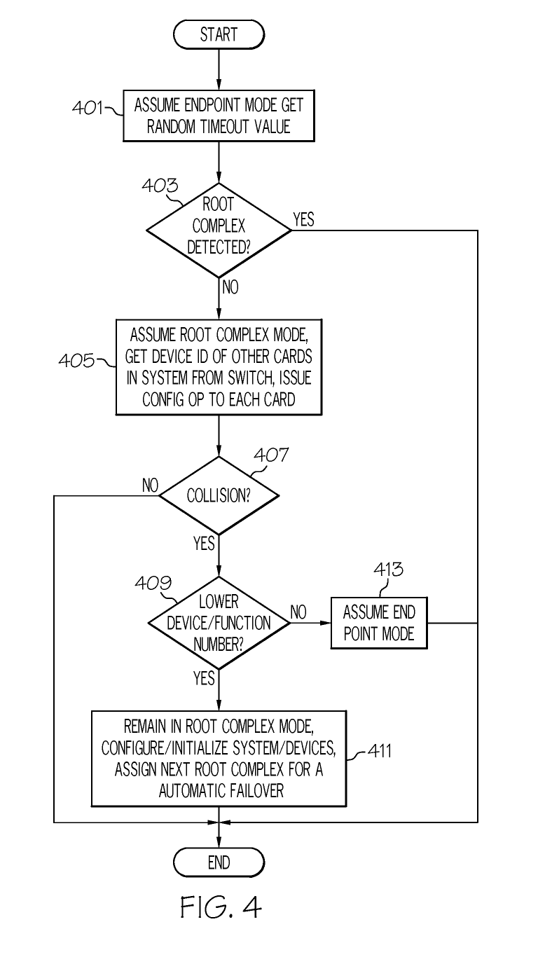

FIG. 4 is a flow chart of an embodiment of initialization processing that may be performed by each combination root complex and endpoint capable device upon system startup. A device assumes endpoint mode and gets a random timeout value, as indicated at block 401. At the completion of the random timeout value, the device determines, at decision block 403, if a root complex is detected. If so, initialization processing ends with the device remaining in endpoint mode. If, as determined at decision block 403, a root complex is not detected, the device assumes root complex mode, gets the device IDs of the other devices in the PCIe fabric from the switch, and issues a configuration operation to each device in the system, as indicated at block 405. The device then performs collision detection processing, as indicated generally at decision block 407. There can be only one root complex device in a system. Accordingly, root complex devices cannot communicate with each other. When the device issues the configuration operation, it expects to receive a response from each endpoint device in the system. If the device does not receive response from one or more of the other devices, a collision has occurred. If, as determined at decision block 407, no collision has occurred, the device remains in root complex mode and initialization processing ends. If, as determined at decision block 407, a collision has occurred, then the device determines if it has a lower device number than the device or devices with which the collision occurred, as indicated at decision block 409. If so, the device remains in root complex mode, configures or initializes the system, and assigns the next root complex for automatic failover, all as indicated at block 411. In embodiments of the present invention, the assignment of a next root complex for automatic failover includes assigning new device numbers to the endpoints. If, as determined at decision block 409, the device does not have a lower device number than the device or devices with which the collision occurred, the device reverts to endpoint mode, as indicated at block 413, and processing ends.

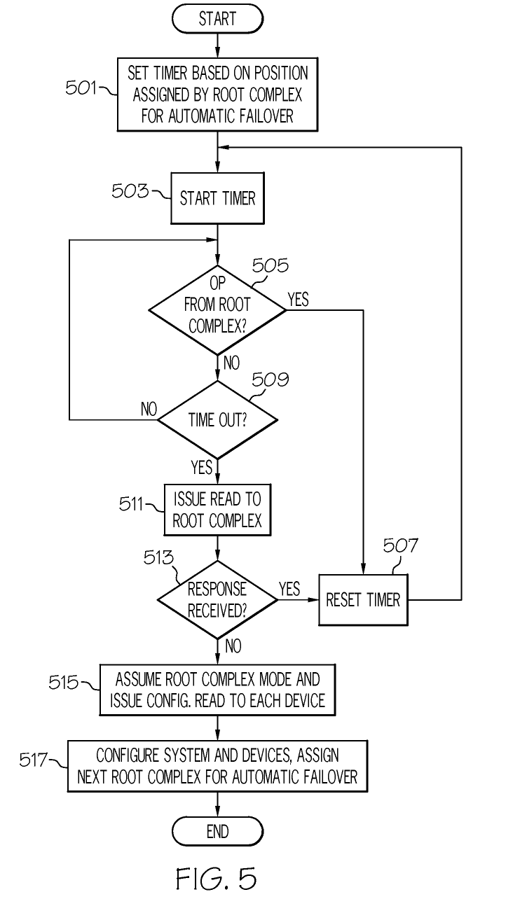

FIG. 5 is a flow chart of automatic failover processing according to an embodiment of the present invention. Each device sets a timer based upon the position assigned to it by the root complex for automatic failover, as indicated at block 501. In embodiments of the present invention, a device multiples a predetermined timeout value by its assigned device number. Thus, device 1 has the shortest timeout value, which is equal to the predetermined timeout value. Device 2 has a timeout value equal to twice the predetermined timeout value, and so on. After setting its timer, the device starts its timer, as indicated at block 503, and waits for the receipt of an operation from the root complex. If, as determined at decision block 505, the device receives an operation from the root complex before the timer times out, the device resets its timer, at block 507, and processing returns to block 503. If, at as determined at decision block 509, the timer times out without the device having received an operation from the root complex, the device issues a read to the root complex, as indicated at block 511, and wait for response. If, as determined at decision block 513, a response is received, the device resets its timer, at block 507, and processing returns to block 503. If, as determined at decision block 513, the device does not receive a response to the read request, the device assumes root complex mode and issues a configuration read to each device, as indicated at block 515. Then, the device configures the system and devices, and assigns an extra complex for automatic failover, all as indicated at block 517. Since each endpoint device has a different timeout value, no collisions can occur between endpoints assuming root complex mode.

From the foregoing, it will be apparent to those skilled in the art that systems and methods according to the present invention are well adapted to overcome the shortcomings of the prior art. While the present invention has been described with reference to presently preferred embodiments, those skilled in the art, given the benefit of the foregoing description, will recognize alternative embodiments. Accordingly, the foregoing description is intended for purposes of illustration and not of limitation.

What is claimed is:

1. A method of configuring a system comprising a root complex device and a plurality of endpoint devices, said method comprising:
detecting a failure of said root complex device; and,
assuming by said one of said endpoint devices root complex mode.

2. The method as claimed in claim 1, wherein said detecting said failure comprises:
issuing, by said one of said endpoint devices, a read request to said root complex device; and,
failing to receive a response to said read request.

3. The method as claimed in claim 2, wherein said detecting said failure further comprises:
waiting a predetermined period after a communication between said root complex device and said one of said endpoint devices before said issuing said read request.

4. The method as claimed in claim 1, further comprising:
assigning to each of said endpoint devices a device number, said device numbers including a lowest device number, wherein said one of said endpoint devices is assigned said lowest device number.

5. The method as claimed in claim 1, wherein said detecting said failure comprises:
starting a timer, said time having a timeout value;
issuing a read request to said root complex device in response to said timer reaching said timeout value.

6. The method as claimed in claim 5, further comprising:
resetting said timer in response to receiving communication from said root complex device prior to said timeout value.

7. The method as claimed in claim 5, further comprising:
resetting said timer in response to receiving a response to said read request.

8. The method as claimed in claim 5, further comprising:
assigning to each of said endpoint devices a different timeout value.

9. The method as claimed in claim 8, further comprising:
assigning to each of said endpoint devices a device number, wherein said different timeout values are assigned according to device number.

10. A multiprocessor system, which comprises:
a plurality of processors;
a plurality of combination root complex and endpoint capable devices coupled one-to-one with said processors; and,
a switch coupled to said combination root complex and endpoint capable devices.

11. The system as claimed in claim 10, wherein:
a first of said combination root complex and endpoint capable devices is configured to operate in a root complex mode; and,
said combination root complex and endpoint capable devices, other than said first device, are each configured to operate in an endpoint mode.

12. The system as claimed claim 11, further comprising:
means for causing one of said devices other than said first device to assume root complex mode upon failure of said first device.

13. The system as claimed in claim 11, wherein each of said combination root complex and endpoint capable devices comprises:
means for selectively assuming one of a root complex mode and an endpoint mode;
means for detecting a failure of a device in said root complex mode; and,
means for transitioning from said endpoint mode to said root complex mode in response to detecting a failure of a device in said root complex mode.

14. The system as claimed in claim 13, wherein said detecting means comprises:
a timer, said timer having a timeout value; and,
means for issuing a read to said root complex in response to said timer reaching said timeout value.

15. The system as claimed in claim 14, wherein said detecting means further comprise:
means for resetting said timer in response to receiving communication from said root complex device.

16. The system as claimed in claim 14, wherein said detecting means further comprise:
means for resetting said timer in response to receiving a response to said read.

17. A method of configuring a system comprising a plurality of combination root complex capable and endpoint capable devices, said method comprising:
configuring a first of said devices to operate in a root complex mode; and,
configuring said devices other than said first device to operate in an endpoint mode.

18. The method as claimed in claim 17, further comprising:
configuring one said other devices to operate in said root complex mode in response to a failure of said first device.

19. The method as claimed in claim 18, further comprising:
assigning to each of said other devices a device number, wherein said one of said other devices is assigned a lowest device number.

20. The method as claimed in claim 18, wherein each of said other devices is operable to assume said root complex mode after waiting a predetermined time without receiving communication from said first device, and wherein said predetermined time for said one of said other devices is less than the predetermined time for said other devices.
